(19) United States
(12) Patent Application Publication
(10) Pub. No.: US 2021/0125207 A1
(43) Pub. Date: Apr. 29, 2021

(54) MULTI-LAYERED MARKET FORECAST FRAMEWORK FOR HOTEL REVENUE MANAGEMENT BY CONTINUOUSLY LEARNING MARKET DYNAMICS

(71) Applicants: SOMNATH BANERJEE, sunnyvale, CA (US); RIMO DAS, sunnyvale, CA (US); HARSHINDER CHADHA, hayward, CA (US); KURIEN JACOB, new york, NY (US)

(72) Inventors: SOMNATH BANERJEE, sunnyvale, CA (US); RIMO DAS, sunnyvale, CA (US); HARSHINDER CHADHA, hayward, CA (US); KURIEN JACOB, new york, NY (US)

(21) Appl. No.: 16/788,317

(22) Filed: Feb. 12, 2020

Related U.S. Application Data
(60) Provisional application No. 62/927,134, filed on Oct. 29, 2019.

(51) Int. Cl. G06Q 30/02; G06Q 50/12; G06Q 10/04; G06F 16/25; G06N 20/00

(52) U.S. Cl. CPC G06Q 30/0204; G06Q 50/12; G06N 20/00; G06F 16/254; G06Q 10/04

(57) ABSTRACT

In one aspect, a computerized method for implementing multi-layered market forecast framework for hotel revenue management by continuously learning market dynamics includes the step of collecting a set of data from various relevant providers, wherein the set of data comprises market data, events information relevant to a market, and market pricing. The method includes the step of implementing an extract, transform, load (ETL) operations on the set of data, wherein the ETL comprises the ingestion of the multi-textured data into big data storage for use on demand basis. The method includes the step of implementing one or more specified data cleaning operations on the set of data. The method includes the step of implementing one or more specified feature engineering operations on the cleaned data. The method includes the step of generating an Average daily rate (ADR) training data set. The method includes the step of generating an occupancy training data set. The method includes the step of building an ADR model using the ADR training data. The method includes the step of building the occupancy model using the occupancy training data. The method includes the step of, with the ADR model and the occupancy model, generating a prediction data set. The method includes the step of, with the prediction data set, generating a forecast for a specified set of rates for a specific hotel. The method includes the step of, with the accuracy trackers, evaluating the multi-layered market forecaster and update the multi-layered market forecaster model to ensure its accuracy.

### CROSS-REFERENCE TO RELATED APPLICATIONS

This application is a continuation in part of U.S. Patent Provisional Application No. 62/927,134, titled MULTI-LAYERED MARKET FORECAST FRAMEWORK FOR HOTEL REVENUE MANAGEMENT BY CONTINUOUSLY LEARNING MARKET DYNAMICS and filed on 29 Oct. 2019. This application is hereby incorporated by reference in its entirety.

### FIELD OF THE INVENTION

The invention is in the field of machine learning and more specifically to a method, system and apparatus of multi-layered market forecast framework for hotel revenue management by continuously learning market dynamics.

### DESCRIPTION OF THE RELATED ART

Revenue management is an ongoing process and it is essential for hoteliers to broaden their revenue strategy to respond to changes in dynamic market conditions. A market is composed of a set of hotels in a well-defined geographic region. Markets can be affected by seasonality, wide-scaled events in the region, weather and economic trends. To that end, taking multi-textured data into account has become important; this data might include market demand patterns, market pricing, events, flights, weather, as well as macro and micro economic trends. For instance, with the increasing trend of alternative supply (e.g. Airbnb or vacation rentals) and new inventory that have a suppressive effect on ADR, hoteliers need to understand the market now more than ever before. Currently, hotel revenue managers in the industry are using human-intuition and simple statistical models to forecast market demand. These forecasting methods are primitive and inaccurate because they do not capture the exogenous factors affecting the market, nor capable of handling very large data sets of current times which is exploding in volume and velocity. The multi-layered market forecast addresses these shortcomings by using sophisticated and scalable machine learning algorithms that can process large data repositories and extract external factors affecting the market. The algorithm forecasts performance measures (Rooms, Occupancy, ADR, RevPAR, and Revenue) both at an aggregate level and also at segmented levels to facilitate prescriptive actions at a particular segment level.

### BRIEF SUMMARY OF THE INVENTION

In one aspect, a computerized method for implementing multi-layered market forecast framework for hotel revenue management by continuously learning market dynamics includes the step of collecting a set of data from various relevant providers, wherein the set of data comprises market data, events information relevant to a market, and market pricing. The method includes the step of implementing the extract, transform, load (ETL) operations on the set of data, wherein the ETL comprises the ingestion of the multi-textured data into big data storage for use on an on demand basis. The method includes the step of implementing one or more specified data cleaning operations on the set of data. The method includes the step of implementing one or more specified feature engineering operations on the cleaned data. The method includes the step of generating an Average daily rate (ADR) training data set. The method includes the step of generating an occupancy training data set. The method includes the step of building an ADR model using the ADR training data. The method includes the step of building the occupancy model using the occupancy training data. The method includes the step of, with the ADR model and the occupancy model, generating a prediction data set. The method includes the step of, with the prediction data set, generating a forecast for a specified set of rates for a specific hotel. The method includes the step of providing a market forecaster, wherein the market forecaster utilizes a machine-learning gradient boosting framework to build the ADR model and the occupancy model.

### BRIEF DESCRIPTION OF THE DRAWINGS

FIG. 1 illustrates an example process for implementing a machine-learning system for a market forecaster algorithm for hotel-bookings, according to some embodiments.

FIG. 2 provides a sample of the type of data set.

FIG. 3 illustrates the training and test data sources including historical market data consisting of KPIs like Occupancy, ADR, RevPAR for each trip start date and trip end date (booking window) market pricing, and optional data like events information, weather, flights, macroeconomic indicators, according to some embodiments.

FIG. 4 illustrates an example process for implementing feature engineering, according to some embodiments.

FIG. 5 illustrates an example modelling process, according to some embodiments.

Markets have a common set of features that are shared across markets known as global features, as illustrated in FIG. 6, according to some embodiments.

FIG. 7 illustrates an example accuracy tracker in process, according to some embodiments.

FIGS. 8-13 illustrate the daily accuracy tracker according to some embodiments.

FIGS. 14-16 illustrate the monthly accuracy tracker according to some embodiments.

FIGS. 17-19 illustrate the worst offenders accuracy tracker according to some embodiments.

FIG. 20 depicts an exemplary computing system that can be configured to perform any one of the processes provided herein.

The Figures described above are a representative set, and are not exhaustive with respect to embodying the invention.

### DESCRIPTION

Disclosed are a system, method, and article of multi-layered market forecast framework for hotel revenue management by continuously learning market dynamics. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, the appearances of the phrases “in one embodiment,” “in an embodiment,” and similar language throughout this specification may, but do not necessarily all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Average daily rate (ADR) is a lodging industry statistic. In one example, ADR represents the average price or rate for each hotel room sold for a specific day.

Big data is a field that treats ways to analyze, systematically extract information from, or otherwise deal with data sets that are too large or complex to be dealt with by traditional data-processing application software. In one example embodiments, big data information can include the following: sixty plus million market reservation data; one-hundred and twenty distinct markets; one hundred gigabytes (GB) plus of data and counting; thirty million and plus event records; one terabyte data of information about, inter alia: flights, events, and weather data; and one billion plus market occupancy and pricing records.

Cloud computing can involve deploying groups of remote servers and/or software networks that allow centralized data storage and elastic online access (meaning when demand is more, more resources will be deployed and vice versa) to computer services or resources. These groups of remote serves and/or software networks can be a collection of remote computing services.

Data cleaning is the process of detecting and correcting (or removing) corrupt or inaccurate records from a record set, table, or database and refers to identifying incomplete, incorrect, inaccurate or irrelevant parts of the data and then replacing, modifying, or deleting the dirty or coarse data. Data cleansing may be performed interactively with data wrangling tools, or as batch processing through scripting.

Extract, transform, load (ETL) is the general procedure of copying data from one or more sources into a destination system which represents the data differently from the source(s) or in a different context than the source(s).

Feature engineering includes the process of using domain knowledge of the data to create features that make machine learning algorithms perform optimally.

Long short-term memory (LSTM) is an artificial recurrent neural network (RNN) architecture used in the field of deep learning. Unlike standard feedforward neural networks, LSTM has feedback connections.

Regression analysis is a set of statistical processes for estimating the relationships among variables. Regression analysis includes various techniques for modeling and analyzing several variables, when the focus is on the relationship between a dependent variable and one or more independent variables (or ‘predictors’). Regression analysis can provide information on how the typical value of the dependent variable (e.g. a criterion variable) changes when any one of the independent variables is varied, while the other independent variables are held fixed.

RevPAR (revenue per available room) is a performance metric for hotels. It can be used to assess how well a hotel has managed its inventory and rates to optimize revenue. It can be calculated by multiplying occupancy by ADR.

Shoulder are dates that fall very close to peak high or low demand dates for hotel bookings.

### EXAMPLE METHODS

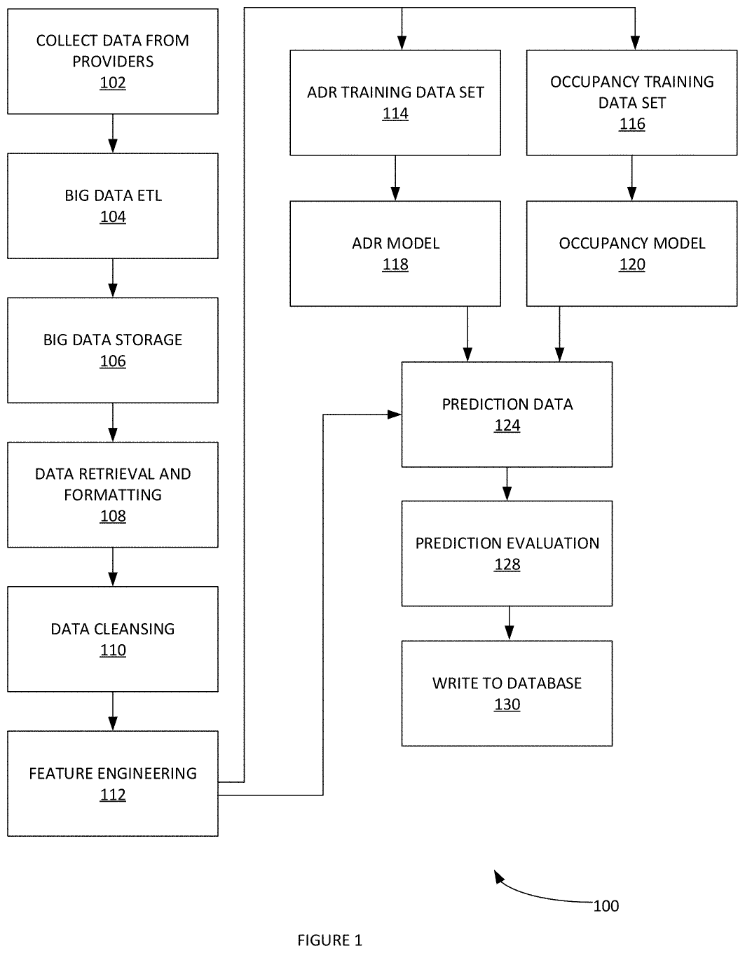

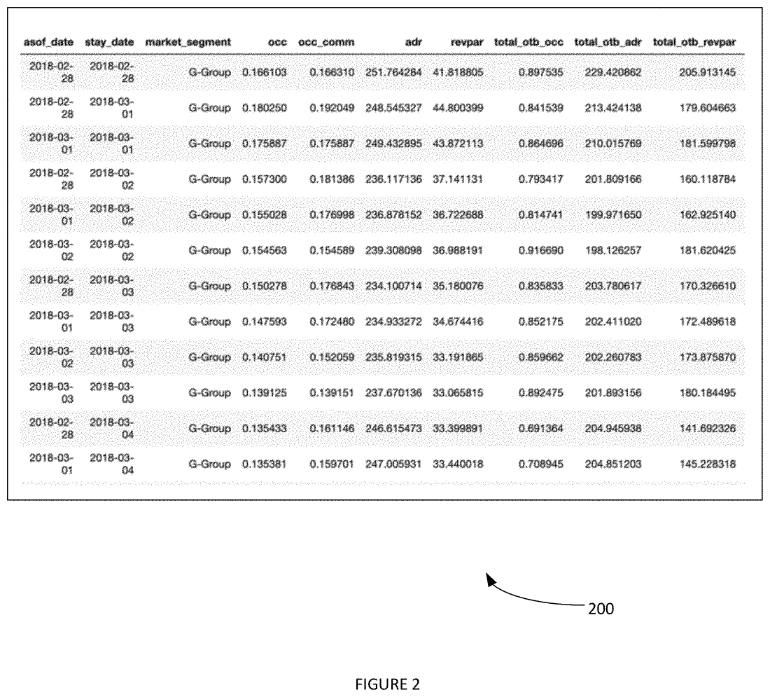

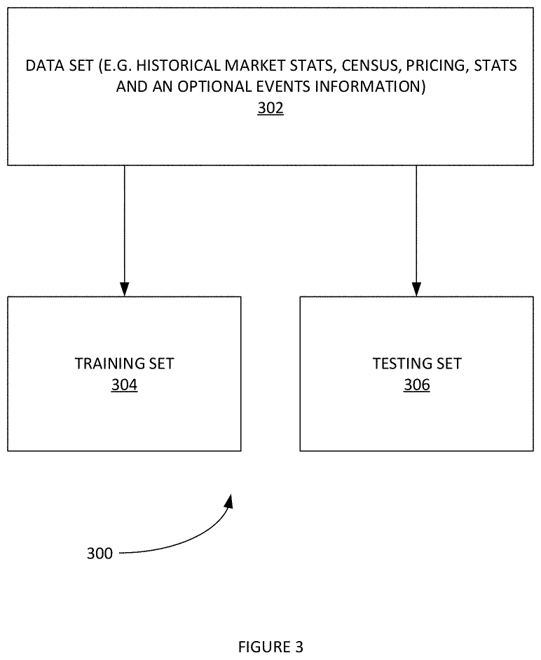

FIG. 1 illustrates an example process 100 for implementing multi-layered market forecast framework for hotel revenue management by continuously learning market dynamics, according to some embodiments. The forecaster uses several data sources including historical market data consisting of KPIs like Occupancy, ADR, RevPAR for each trip start date and trip end date (booking window), market pricing, and optional data like events information, weather, flights, macroeconomic indicators. These data sources are compiled into a singular data set. In one example, process 100 can use a minimum of one year of historical data. It is noted that, FIG. 1 illustrates an overview of the process and FIGS. 2 and 3 illustrate the training and test data sources. The test data source contains historical actualized KPI (Occupancy, ADR, RevPAR) data for the market and is used to validate the accuracy and health of the forecast. 200 and 300 include historical segmented and aggregated market data consisting of KPIs like Occupancy, ADR and RevPAR, market pricing and optional events information, according to some embodiments. These data sources are compiled and are split into two separate training data sets: ADR and Occupancy. Each training data set is used to build a model for its respective KPI (Occupancy or ADR) and a single prediction data set is used as an input into the Occupancy and ADR model for prediction on Occupancy and ADR. The Occupancy training data set includes information on historical Occupancy, and ADR, market pricing, and—optional events information. The ADR training data set includes information on historical Occupancy, and ADR, market pricing, and optional events information.

These data sources are merged into a singular data set. More specifically, in step 102, process 100 collect data from various relevant providers. This includes market data (market Occupancy, ADR, and RevPAR), events information relevant to a market, and market pricing. In step 104, process 100 implement Big data ETL, which includes the ingestion of the multi-textured data (outlined in step 100) into Big Data storage for use on demand basis, step 106. In step 108, the data can be retrieved and formatted. The data can be subdivided into event and market data. The events data (Holidays, festivals, trade shows, conferences, sports, weather, etc.) consists of information of the event's date(s) and the market where the event is occurring. The events data is formatted by including shoulder dates, which is done by identifying the surrounding days of an event in a market and including that information in the event data. This is dynamically identified by observing what month and days of the year the event is happening. These days are treated the same as event days. The market and events data is then merged together into a singular data set. In step 110, data cleaning can be implemented to improve the quality of the data. This includes imputation of missing data and the removal of erroneous values and outliers. In step 112, feature engineering can be implemented on the clean data. This involves applying domain expertise and creating new features that help derive new insights from the original data source. Additional information on feature engineering is provided infra. ADR training data set 114 and occupancy training data set 116 are then generated.

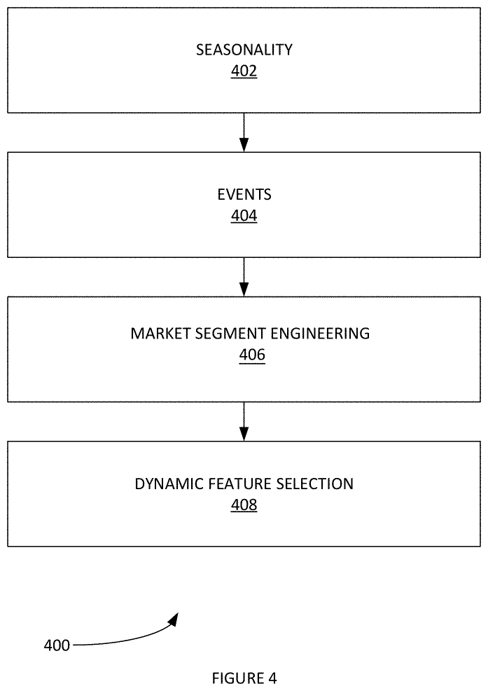

FIG. 4 illustrates an example process 400 for implementing feature engineering, according to some embodiments. Markets have a common set of features that are shared across markets known as global features, as illustrated in FIG. 6 infra, according to some embodiments. However, there are certain attributes that are exclusive to an individual market known as local features. In the hospitality industry, seasonality is very significant. In step 402, seasonality methods can be implemented. Seasonality is a factor because that affects customer behavior. Seasonality can be described as low, moderate, high or peak demand categorized by monthly behavior. This significantly affects market performance indicators—Occupancy, ADR and RevPAR. The relevant demand can be used by process 100 in its various machine learning processes.

Example machine learning algorithms used in the Multi-Layered Market Forecaster can include, inter alia: gradient boosting and bagging decision tree algorithms (e.g. such as LightGBM, CatBoost, XGBoost and also Deep Learning Networks like LSTM). Additionally, ensemble machine learning algorithms can be used. For example, a Stacking Regressor which incorporates several machine learning algorithms mentioned herein. In one example, a stacking can be an ensemble learning technique to combine multiple regression models via a meta-regressor.

Since the market demand varies monthly for each market, four demand buckets are dynamically computed and used as a quantitative measure for demand. These buckets are formed on the basis of using one (1) year of actualized market data.

The same methodology can be applied on a weekly level as well. At the weekly level, each day of the week is affected by seasonality. Process 400 can also determine which days are low, moderate or peak, are just critical. Seasonality at the weekly level can be dynamically computed as well. Another measure for seasonality is provided by transforming the day of the week and month with various trigonometric functions. In the hospitality industry, the day of the week and month of the year are cyclical and exhibit the same pattern year-round. To capture this periodicity, the cyclical nature of sine and cosine are applied to the month and day of the week.

Another factor with forecasting events is that there are events that have dates shifted year over year, events that shift market to market and shifting holiday dates (e.g. Thanksgiving, Labor Day, etc.). The forecaster of process 400 can handle any type of event. Process 400 can use an indicator variable (binary variable), 1 to indicate an event and its shoulder dates and 0 for non-event dates. Shoulder dates as mentioned in herein are day(s) that are surrounding the event date(s). Process 400 can be used by a model to learn the historical booking pace for events and shoulder dates.

In step 406, process 400 incorporates market segment engineering data and transforms them suitably to better represent the dataset. Data is taken by market segments to define different customer groups based on their travel behavior which can include, inter alia: retail, discount, wholesale, qualified, negotiated, corporate, group, etc. The purpose is to help distinguish between various types of travelers and who will respond similarly to specific revenue strategies. This helps hotel revenue managers to be more adequate with their resources and target appropriate customer segments in effective ways.

The group segment requires special consideration and treatment. Group reservations can be indicators of events such as conferences, concerts or trade shows that are happening in a market. Markets that have events year-round pay acute attention to group reservations. Group reservations in hotels are sold in blocks, which has a cascading effect on inventory and pricing. Group reservations highly affect a hotel's performance measures (Rooms, Occupancy, ADR, RevPAR and Revenue) because hotel revenue managers create pricing strategies based on this segment, which in turn affects Occupancy, ADR, RevPAR and Revenue for other market segments. These reservations can be split up into two distinct categories: group committed and group-sold.

The group-committed segment are customers who commit to buying a block of rooms but have not bought yet. The group-bought segment are group reservations that were committed and officially sold. These two segments are very critical because they are prone to cancellations (group wash). This requires special attention because cancellations can be erratic and impactful. To account for this, a feature can be used for the cancellations called the delta occupancy. This variable can be created by measuring the difference between the group-committed and group-bought occupancy. With this feature, the model can learn about cancellation patterns and its effects on the actualized occupancy.

In step 408, process 400 can implement Dynamic Feature Selection operations. It is noted that, as mentioned supra, different markets behave in different ways and therefore local features are weighted differently, while global features remain the same. Process 400 can dynamically select the best set of features for a particular market. This allows each market to have its own unique set of features and ensures that the machine learning algorithm has been designed specifically to fit the trends and characteristics of that market.

Returning to process 100, in one example of process 100, ADR training data set 114 and an occupancy training data set 116 can be used for modeling. Process 100 builds two models, ADR model 118 and occupancy model 120, by using the ADR training data and occupancy training data, respectively. The parameters of both Occupancy and ADR models are hyper tuned (hyperparameter optimization), which means that machine learning algorithms are structured optimally (to overcome overfitting or underfitting) for the learning process. Also, with these two models, the prediction data 124 is used to generate a forecast for occupancy, ADR, RevPAR and revenue.

FIG. 5 illustrates an example modelling process 500, according to some embodiments. Process 500 can utilize ADR model 118 and occupancy model 120. In this section, an example model used to design the market forecaster is provided. In one example, process 500 utilizes machine learning gradient boosting framework that uses tree-based learning algorithm. This algorithm is then used to build two distinct models which forecast Occupancy and ADR. RevPAR is then calculated by using the forecast from Occupancy and ADR. Revenue is calculated by using market capacity (rooms) and RevPAR.

The occupancy forecast at an aggregate level by the machine learning model is unconstrained occupancy which means the total demand for a particular date irrespective of the capacity of the market. In reality, total market demand cannot exceed the capacity of the market (100% capacity). Therefore, there is a need to constrain this occupancy known as the constrained occupancy or demand, which is within the availability constraints of market (100% capacity). The unconstrained occupancy forecast from the machine learning model is constrained by proportionately decreasing the occupancy at a market segment level, which ensures that the market demand does not exceed market inventory.

An example implementation of a machine learning gradient boosting framework is now discussed. In one example, a LightGBM regressor can be used as the tree-based regressor. Then process 500 can split the data set into a training set and test set (e.g. see FIG. 3 supra). The training set can be one (1) year of historical data and the test set can be four (4) months of test data containing historical actualized KPI (Occupancy, ADR, RevPAR) values. The model can be fitted on the training set and then predictions on the test set can be made. The predictor used for the ADR model is the historical actual ADR and the predictor used for the Occupancy model is the total demand interested in booking from the current date onward only (e.g. the difference between actual reservations and reservations already booked as of current date). Example test results are discussed infra.

In one example, machine learning algorithm LightGBM can be implemented. The LightGBM is a gradient boosting decision tree algorithm. The LightGBM can handle larger data sets while keeping the efficiency and accuracy. The LightGBM can be implemented as follows. The categorical variables in the input data needed to be transformed from strings to categorical data types. These categorical variables can be, inter alia: market segment, month, day of the week, and season. Then, the LightGBM Regressor can be fitted on one (1) year of historical data. Next, a prediction can be made on the test set. Example test results are discussed infra.

In step 502, process 500 can implement a gradient boosting regressor. In step 504, process 500 can implement various results-based operations. In one example, process 500 can compare the two models and review/analyze the standard error metrics and the key event days in the market. The error metrics can be, inter alia: mean absolute error (MAE) for the occupancy models and mean absolute percentage error (MAPE) for the ADR models. Along with comparing the metrics, the forecast on key event days were evaluated with the historical actualized KPIs (Occupancy, ADR, RevPAR.). As mentioned supra, with a large amount of multi-textured market data across numerous dimensions, LightGBM algorithm is fitting to model this kind of convoluted nonlinear feature interactions and high variance event days. The Occupancy and ADR built from the LightGBM regressor had satisfactory results.

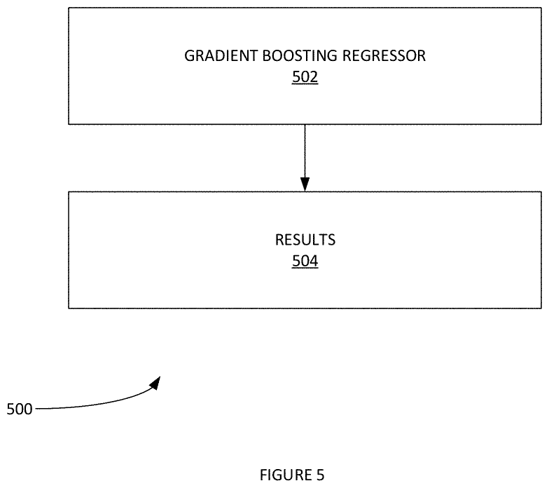

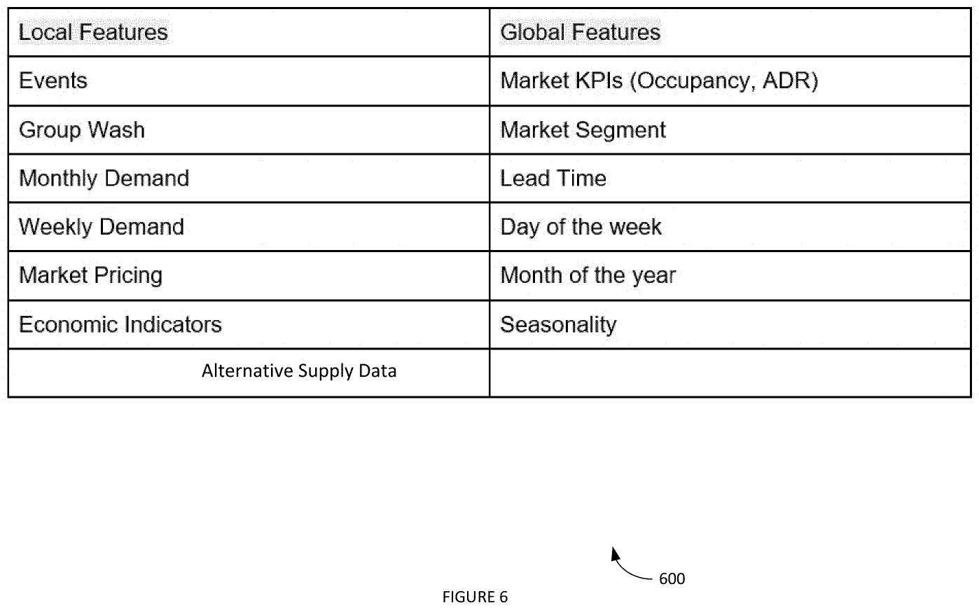

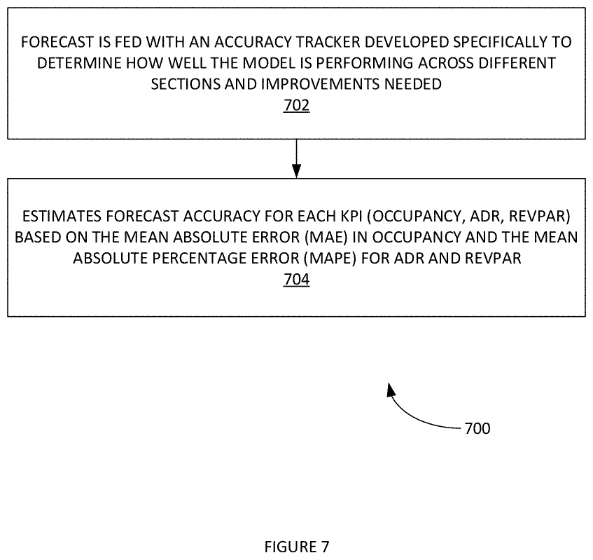

FIG. 7 illustrates an example accuracy tracker in process 700, according to some embodiments. The ML model can forecast with high predictive accuracy as more accurate the model forecast is the better business decisions can be. In step 702, the forecast can be fed with an accuracy tracker developed specifically to determine how well the model is performing across different sections and improvements needed (if any). In step 704 process 700 estimates forecast accuracy for each KPI (Occupancy, ADR, RevPAR) based on the Mean Absolute Error (MAE) in Occupancy and the Mean Absolute Percentage Error (MAPE) for ADR and RevPAR. The accuracy tracker demonstrates the health of the forecast across different performance measures according to requirements such as daily and monthly categorized by Lead times/Days Before Arrival (time between the date of engagement/reservation and actualized date).

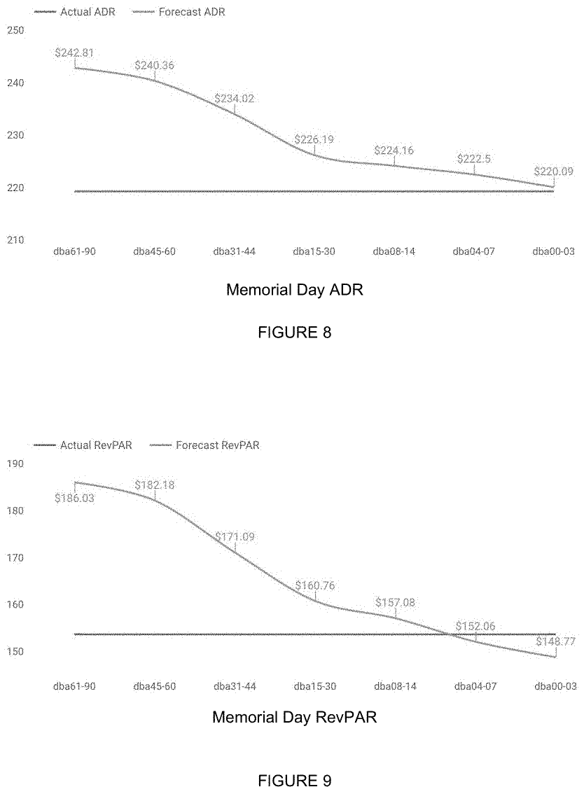

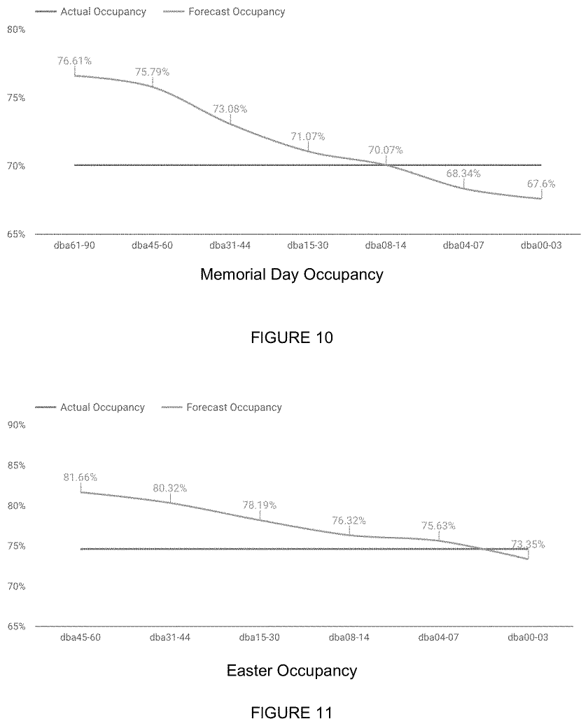

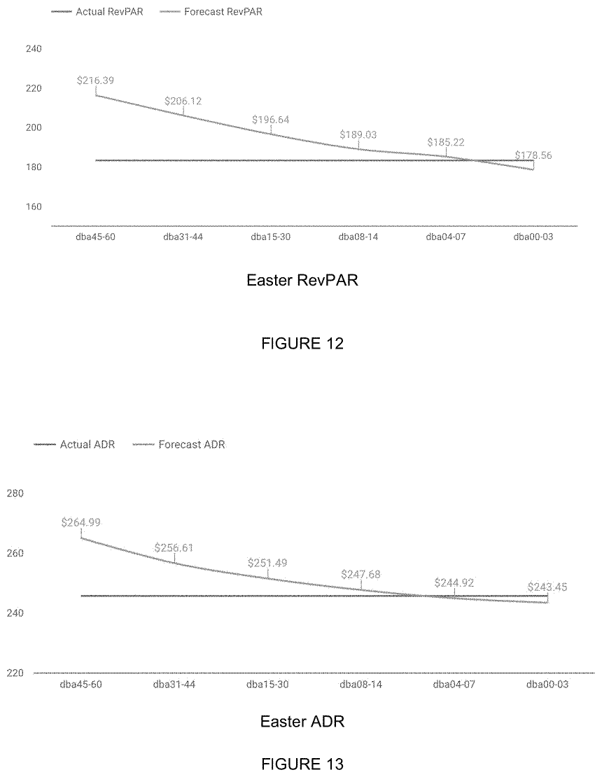

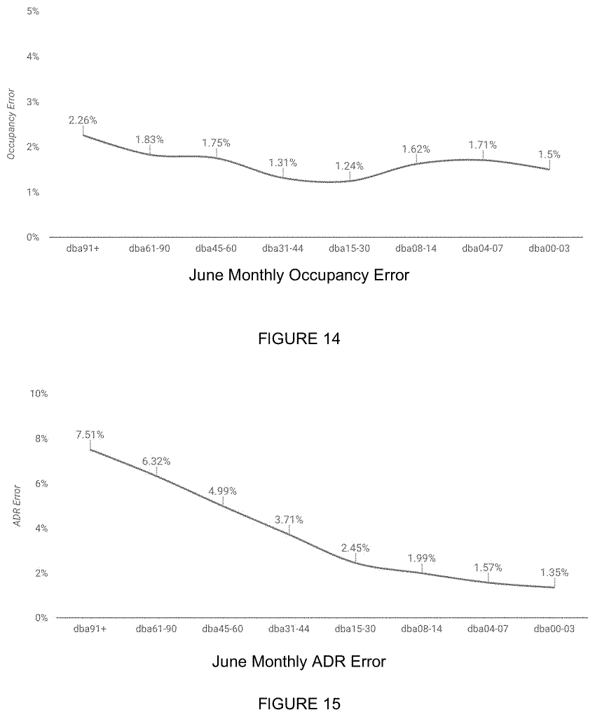

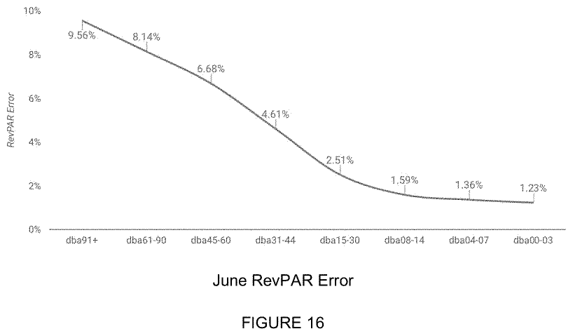

FIGS. 8-13 illustrate the daily accuracy tracker according to some embodiments. FIGS. 14-16 illustrate the monthly accuracy tracker according to some embodiments. The forecast is first split into several buckets by the days before arrival for a particular date. The forecast is the average amongst those buckets and then compared to the actualized measure. As can be seen from the FIGS. 8-13, these can be evaluated across all KPIs. As an illustration, user can observe how the forecasts fared on the key event days for the New York market (e.g. Easter, Memorial Day, etc.).

FIGS. 14-16 illustrate the monthly accuracy tracker according to some embodiments. The forecast is evaluated by days before arrival buckets. The process is based on the outline infra. All of the daily accuracy trackers are aggregated on a monthly level by taking the average of all the days in the month and respective days before arrival buckets. As can be seen from the FIGS. 14-16, these can be evaluated across all KPIs. As an illustration, users can observe how the forecasts fared on the month of June for the New York market.

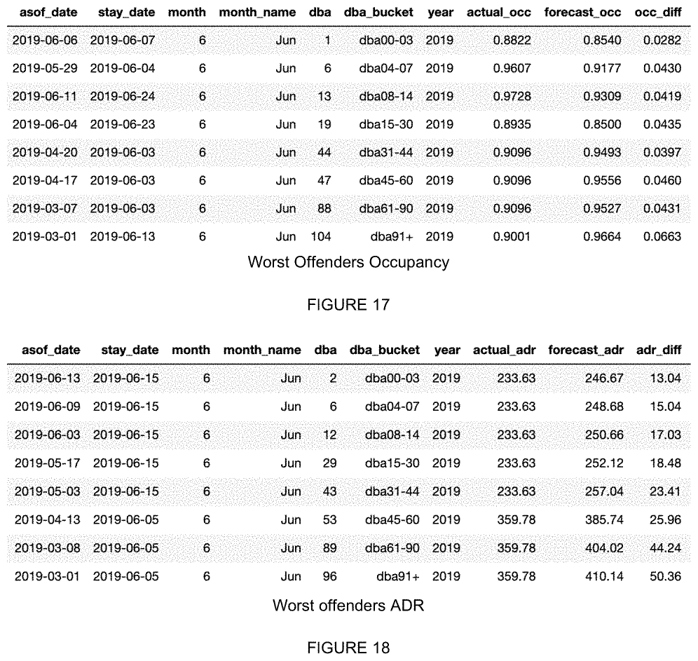

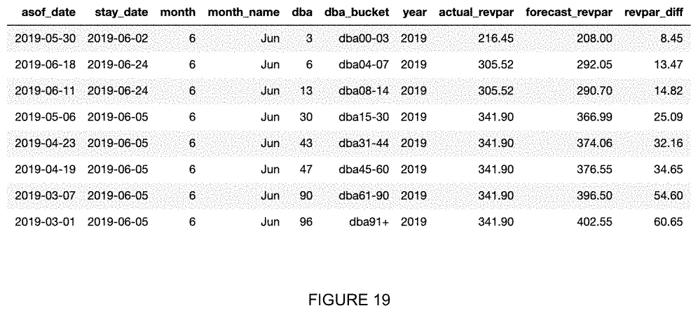

FIGS. 17-19 illustrate the worst offenders accuracy tracker according to some embodiments. This accuracy tracker details the worst performing forecast in the month for each bucket. This provides information as to which days the forecast is not performing optimally. As can be seen in FIGS. 17-19, these can be evaluated across all KPIs. As an illustration, a user can observe the worst offenders in the month of June for the New York market.

Returning to process 100, the market data is split into two separate training (114 and 116) and prediction sets (124). In step 124 the prediction dataset has data for the next 365 days and is used to generate forecasts for ADR and Occupancy (constrained and unconstrained), by using ADR model (118) and Occupancy model (120), respectively. Thereafter, RevPAR and revenue is calculated as mentioned supra for the prediction dataset. Prediction evaluation (128) is then conducted by the accuracy trackers. Finally, the market forecast for various KPIs are written to the database (130).

### Additional Exemplary Systems

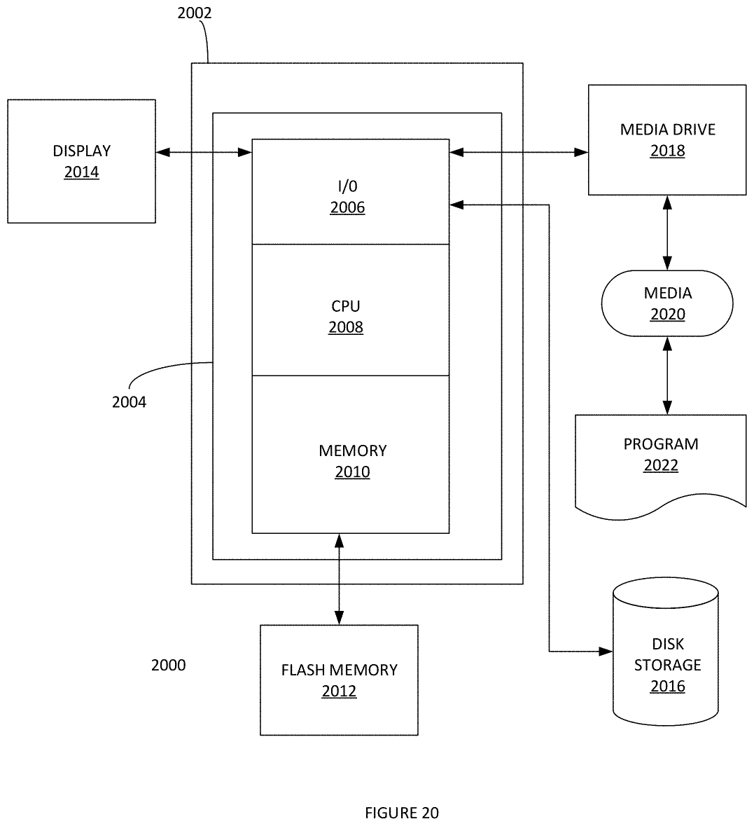

FIG. 20 depicts an exemplary computing system 2000 that can be configured to perform any one of the processes provided herein. In this context, computing system 2000 may include, for example, a processor, memory, storage, and I/O devices (e.g., monitor, keyboard, disk drive, Internet connection, etc.). However, computing system 2000 may include circuitry or other specialized hardware for carrying out some or all aspects of the processes. In some operational settings, computing system 2000 may be configured as a system that includes one or more units, each of which is configured to carry out some aspects of the processes either in software, hardware, or some combination thereof.

FIG. 20 depicts computing system 2000 with a number of components that may be used to perform any of the processes described herein. The main system 2002 includes a motherboard 2004 having an I/O section 2006, one or more central processing units (CPU) 2008, and a memory section 2010, which may have a flash memory card 2012 related to it. The I/O section 2006 can be connected to a display 2014, a keyboard and/or other user input (not shown), a disk storage unit 2016, and a media drive unit 2018. The media drive unit 2018 can read/write a computer-readable medium 2020, which can contain programs 2022 and/or data. Computing system 2000 can include a web browser. Moreover, it is noted that computing system 2000 can be configured to include additional systems in order to fulfill various functionalities. Computing system 2000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consists of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (for example in cross-validation), the test dataset is also called a holdout dataset.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for implementing multi-layered market forecast framework for hotel revenue management by continuously learning market dynamics comprising:
collecting a set of data from various relevant providers, wherein the set of data comprises market data, events information relevant to a market, and market pricing;
implement extract, transform, load (ETL) operations on the set of data, wherein the ETL comprises the ingestion of the multi-textured data into big data storage for use on demand basis;
implementing one or more specified data cleaning operations on the set of data;
implementing one or more specified feature engineering operations on the cleaned data;
generating an Average daily rate (ADR) training data set;
generating an occupancy training data set;
building an ADR model using the ADR training data;
building the occupancy model using the occupancy training data;
with the ADR model and the occupancy model, generating a prediction data set;
with the prediction data set, generating a forecast for a specified set of rates for a specific hotel; and
providing a market forecaster, wherein the market forecaster utilizes a machine-learning gradient boosting framework to build the ADR model and the occupancy model.

2. The computerized method of claim 1, wherein the market data comprises a set of market occupancy data.

3. The computerized method of claim 2, wherein the market data comprises a set of ADR data.

4. The computerized method of claim 3, wherein the market data comprises a set of revenue per available room (RevPAR) data.

5. The computerized method of claim 1, wherein the one or more specified data cleaning operations on the set of data comprises an imputation operation on a set of missing data and a removal of a set of erroneous values and outliers.

6. The computerized method of claim 5, wherein the one or more specified feature engineering operations on the clean data comprises applying a domain expertise operation on the clean data and creating one or more specified features that are used to derive an insight from the original data source.

7. The computerized method of claim 1, wherein the ADR training set comprises information on historical occupancy data, ADR data, RevPAR data, market pricing data, optional events and market segmented information, seasonality factor data.

8. The computerized method of claim 7, wherein the seasonality factor data comprises demand on a weekly, monthly and quarterly level, and a lead time/Days Before Arrival of the arrival date.

9. The computerized method of claim 1, wherein the occupancy training data set comprises information on historical occupancy data, ADR data, RevPAR data, market pricing data, optional events and market segmented information, seasonality factor data.

10. The computerized method of claim 1, wherein a set of parameters of the occupancy model and the ADR model are hyper tuned using hyperparameter optimization operations with one or more machine learning algorithms that are structured optimally to overcome overfitting or underfitting for a learning process.

11. The computerized method of claim 1, wherein the specified set of forecasted rates comprises a forecasted occupancy rate.

12. The computerized method of claim 11, wherein the specified set of forecasted rates comprises a forecasted ADR rate.

13. The computerized method of claim 12, wherein the specified set of forecasted rates a forecasted RevPAR rate.

14. The computerized method of claim 13, wherein the specified set of forecasted rates comprises a forecasted revenue value.

15. The computerized method of claim 14, wherein the machine-learning gradient boosting framework implements a tree-based learning algorithm to build the ADR model and the occupancy model.

16. The computerized method of claim 15, wherein the forecasted RevPAR rate is calculated by using a forecast from occupancy model and the ADR model.

17. The computerized method of claim 16, wherein the forecasted revenue value is calculated by using a market capacity based on a number of available rooms and the forecasted RevPAR rate.

18. The computerized method of claim 17, wherein the occupancy data, ADR data, RevPAR data, rooms data, and revenue data are forecasted at a market segment level, wherein the market segment level comprises a group market segment, and wherein the group market segment accounts for any group cancellations in a given market.

19. The computerized method of claim 18, wherein the accuracy trackers comprises daily, monthly, worst offenders that categorized into an overall category and a segmented category and, are used to evaluate the multi-layered market forecaster and are used to update the multi-layered market forecaster model to ensure that it maintains its accuracy.
